(19) United States
(12) Patent Application Publication
(10) Pub. No.: US 2022/0161452 A1
(43) Pub. Date: May 26, 2022

(54) WIRE TENSIONER DEVICE FOR SLICING FOOD

(71) Applicant: David Michael Hartung, Whitwell, TN (US)

(72) Inventor: David Michael Hartung, Whitwell, TN (US)

(21) Appl. No.: 17/532,486

(22) Filed: Nov. 22, 2021

Related U.S. Application Data
(60) Provisional application No. 63/116,944, filed on Nov. 23, 2020.

(51) Int. Cl. B26D 1/547; B26D 1/00

(52) U.S. Cl. CPC B26D 1/547; B26D 2001/008; B26D 2210/02; B26D 1/0006

(57) ABSTRACT

A food slicing system is provided comprising: a cutting surface extending between first and second ends. A slicing element is provided having a first end pivotably coupled to the cutting surface adjacent to the first end of the cutting surface. A pivot arm includes a first end pivotably coupled to the cutting surface adjacent to the first end of the cutting surface, wherein both the pivot arm and the slicing element have respective lengths extending toward a second end of the cutting surface. A tensioner device couples a second end of the slicing element to a second end of the pivot arm, wherein the tensioner device is configured to allow for adjustment of an amount of tension applied to the slicing element.

### CROSS-REFERENCE TO RELATED APPLICATION(S)

This application is a Non-Provisional application of and claims priority to U.S. Provisional Application No. 63/116,944, filed Nov. 23, 2020 of the same title; the contents of which are hereby incorporated herein by reference.

### FIELD OF THE INVENTION

The present invention relates to a tensioner device used to tension a slicing element, such as a wire, where the wire is used to slice food, and more particularly to a food cutting system having a slicing element in the form of a wire, string, or other cord that is tensioned by an adjustable tensioner.

### BACKGROUND OF THE INVENTION

Cutting boards used for slicing cheese and other food via use of a tensioned wire or cord have been in use for some time and are known to be efficient implements for slicing of food. Conventional cutting boards with slicing wires typically include a wire and a pivot arm coupled to the board. One end of the wire and the pivot arm are each pivotably connected to the cutting board at a distal end of the board. The opposite end of the wire is coupled to the opposite end of the pivot arm, so that as the arm is rotated downward toward a cutting surface of the board, the wire is also rotated downwardly for slicing through food located on the cutting surface of the board.

In conventional cutting board systems, the cutting wire is pretensioned at the factory. It is preinstalled to the board and to the end of the pivot arm and is not meant to be detached or further manipulated in terms of tensioning. As such, the wire is always connected to the board and pivot arm, and its level of tension cannot be changed.

### SUMMARY OF THE INVENTION

The present invention provides a tensioner device that is used in conjunction with a food slicing system. The food slicing system may include a cutting surface and a slicing element, such as a wire. The cutting surface extending between first and second ends. The slicing element comprises a first end pivotably coupled to the cutting surface adjacent to the first end of the cutting surface. A pivot arm having a first end pivotably coupled to the cutting surface adjacent to the first end of the cutting surface, wherein both the pivot arm and the slicing element have respective lengths extending toward a second end of the cutting surface. A tensioner device is configured for coupling a second end of the slicing element to a second end of the pivot arm, wherein the tensioner device is configured to allow for adjustment of an amount of tension applied to the slicing element.

In one embodiment, the tensioner device comprises a rotatable cylinder on which the second end of the slicing element is coiled for adjusting a tension applied to the slicing element via rotation of the cylinder. An adjustment knob may be coupled to the cylinder to thereby rotate the cylinder to thereby adjust the tension applied to the slicing element. In a further embodiment, a pinion gear is coupled to the cylinder and a worm drive in contact with the pinon gear and the adjustment knob, such that rotation of the adjustment knob thereby rotates the cylinder to thereby adjust the tension on the slicing element. In this manner, by adjusting the amount of the slicing element coiled on to the cylinder of the tensioner device, the tension of the slicing element can be regulated to provide proper tension for slicing through foods placed on the cutting surface via rotation of the pivot arm, and thereby the slicing element to contact and slice through the food.

In one embodiment, the respective second ends of the slicing element and the pivot arm extend past the second end of the cutting surface. In this embodiment, the coupling point of the second end of the slicing element and the second end of the pivot arm via the tensioner device does not contact the cutting surface when the pivot arm is rotated toward the cutting surface.

In one embodiment, the pivot arm comprises a body extending between the first and second ends of the pivot arm. A portion of the body of the pivot arm includes a bend to create an offset of the pivot arm from the cutting surface, so that when rotated toward the cutting surface, the pivot arm may rotate past the cutting surface to thereby ensure that the slicing element at least contacts the cutting surface. In other words, the bend in the pivot arm offsets the body of the pivot arm from the cutting surface so that the rotation of the pivot arm toward the cutting surface is not obstructed by the cutting surface. In a further or alternative embodiment, the cutting surface may comprise a groove in the cutting surface extending at least partially from the first end of the cutting surface to the second end of the cutting surface for receiving the slicing element when the pivot arm is brought toward the cutting surface and downwardly past the cutting surface to ensure that the slicing element slices through food located on the cutting surface.

In one embodiment, the offset of the pivot arm from the cutting surface is achieved by a first bend in a body of the pivot arm at a position on the body adjacent to and off-set from the first end of said body and a second bend in the body of the pivot arm at a position on the body adjacent to and off-set from the second end of said body. The first end of the pivot arm is rotatably connected to a side edge of the cutting surface. In this configuration, the first bend in the body offsets the pivot arm so that the pivot arm can rotate downwardly past the cutting surface and the second bend in the body positions the slicing element over the cutting surface for contacting food on the cutting surface.

The slicing element may comprise any structure capable of cutting/slicing through material. For example, the slicing element may be metallic wire, cotton rope, nylon rope, or rope formed of a polymer or plastic material. It might also comprise a structure other than wire, rope, or string. For example, it could be a thin blade structure that is connected to wire on its second end for coupling to the tensioner device.

The cutting surface may be of any suitable material for supporting food while being sliced, such as wood, metal, plastic, glass, stone, or combinations thereof.

The tension device can be any structure suitable for applying a tension to the slicing element, and in some embodiments, an adjustable tension. In one embodiment, the tension device is akin to a guitar string tensioner, such as described herein. But, in general, structures that are capable of coupling to an end of the slicing element and applying a tension thereto are contemplated.

### BRIEF DESCRIPTION OF THE DRAWINGS

FIG. 1 is a top, front perspective view of a food slicing system according to one embodiment of the present invention;

FIG. 2 is a top perspective view of the food slicing system according to the embodiment of FIG. 1;

FIG. 3 is a front perspective view of the food slicing system according to the embodiment of FIG. 1;

FIGS. 4 and 5 are respective front and back side views of a tensioner block of a tensioner device according to one embodiment of the present invention;

FIG. 6 illustrates schematic dimensions of the tensioner block of FIGS. 4 and 5, according to one embodiment of the present invention;

FIGS. 7 and 8 are respectively front and back views of a tensioning system used in a tension device according to one embodiment of the present invention;

FIGS. 9 and 10 are respectively back and front views of a tensioning system of one embodiment assembled with a tensioner block according to one embodiment to form a tensioner device according to one embodiment of the present invention;

FIG. 11 illustrates the tensioner device of FIGS. 9 and 10 coupled to a second end of a pivot arm according to one embodiment of the present invention;

FIG. 12 illustrates the first end of a pivot arm according to one embodiment of the present invention rotatably coupled to a side edge of the cutting surface according to one embodiment of the present invention;

FIG. 13 is a top view of the cutting surface according to one embodiment of the present invention;

FIG. 14 is a top view of the pivot arm according to one embodiment of the present invention;

FIGS. 15A and 15B illustrate coupling the first end of the slicing element to the cutting surface according to one embodiment of the present invention; and

FIGS. 16A and 16B illustrate coupling the second end of the slicing element to the tensioner device and tensioning of the slicing element via the tensioner device according to one embodiment of the present invention.

### DETAILED DESCRIPTION OF THE INVENTION

The present invention relates to a food slicing system that uses a tensioned slicing element, such as a wire, to slice food when the wire is moved toward a cutting surface of the food slicing system, whereby pressure localized by the slicing element slices food. The tension applied to the slicing element is a factor in operation of the slicing element. In the present invention, the food slicing system comprises a tensioner device connected to the slicing element for allowing adjustment of the tension applied to the slicing element to thereby adjust the slicing operation of the food slicing system.

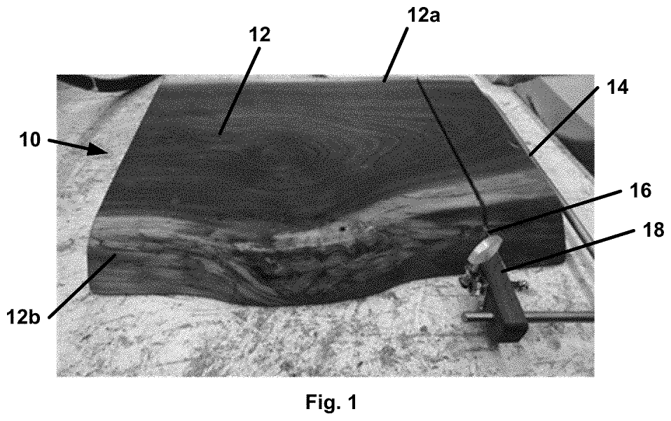

FIG. 1 depicts an assembled food slicing system according to one embodiment of the present invention, in a resting position. The food slicing system 10 includes a cutting surface 12 with a pivot arm 14 and a slicing element 16, where both the pivot arm 14 and the slicing element 16 are coupled to the cutting surface 12 adjacent a first end 12a of the cutting surface 12, with the pivot arm typically being coupled to a side edge of the cutting surface. A tensioner device 18 is coupled between a second end of the slicing element 16 a second end of the pivot arm 14. As will be described later, the tensioner device 18 is configured to apply adjustable tension to the slicing element.

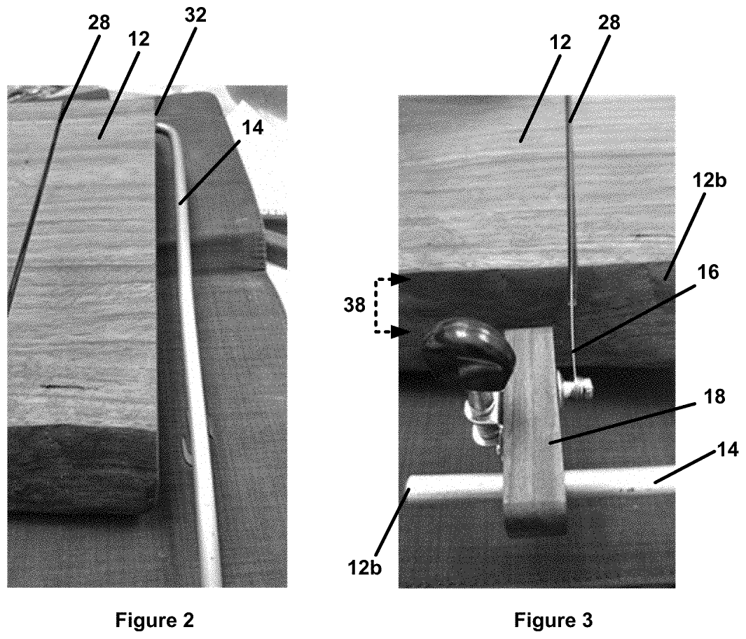

FIG. 2 is a top perspective view and FIG. 3 is a front view of the food slicing system depicted in FIG. 1. As illustrated and discussed later below, the first end of the pivot arm 14 is pivotably connected a side edge 32 of the cutting surface 12. A first bend (not shown in this Figure) in the body of the pivot arm 14 adjacent its first end (14a as shown in other figures) allows the body of the pivot arm 14 to extend substantially parallel to the side edge 32 of the cutting surface 12. As shown in FIG. 3, the second end 14b of the pivot arm 14 of this embodiment extends past a second end 12b of the cutting surface 12. Further, the pivot arm includes a second bend (36, shown in other figures) that places the second end of the pivot arm, and by extension the tensioner device 18 and the second end of the slicing element 16 in front of the second end 12b of the cutting surface 12. This configuration of the pivot arm 14, thereby allows the pivot arm 14 to rotate relative to the cutting surface 12 and avoid both the pivot arm 14 and the tensioner device 18 from contacting or being obstructed by the cutting surface 12 when the pivot arm 14 is rotated toward and past the cutting surface 12 during a slicing operation.

As shown in FIG. 3, through a combination of the chosen length of the pivot arm 14 and where the first end 14a of the pivot arm 14 is coupled to the side edge 32 of the cutting surface 12, an offset distance 38 is created between the tensioner device 18 and the second end 12b of the cutting surface 12, so that the tensioner device 18 does not contact the cutting surface 12 when the pivot arm 14, with the tensioner device 18 coupled to its second end 14b, rotates toward the cutting surface 12. The offset distance 38 and a length L of the tension device 18 (at least a length from where the second end 14b of the pivot arm 14 connects to the tensioner device) define a distance that the second end 14b of the pivot arm 14 extends past the second end 12b of the cutting surface 12.

As further shown in FIGS. 2 and 3, in some embodiments, a groove 28 may be provided in the cutting surface 12. The slicing element 16 is positioned relative to the cutting surface 12 so as to enter the groove 28 when the pivot arm 14 is rotated toward and past the cutting surface 12, so that the slicing element 16 can be rotated past the cutting surface 12 and into the groove 28 to thereby ensure that the slicing element 16 slices completely through food on the cutting surface 12.

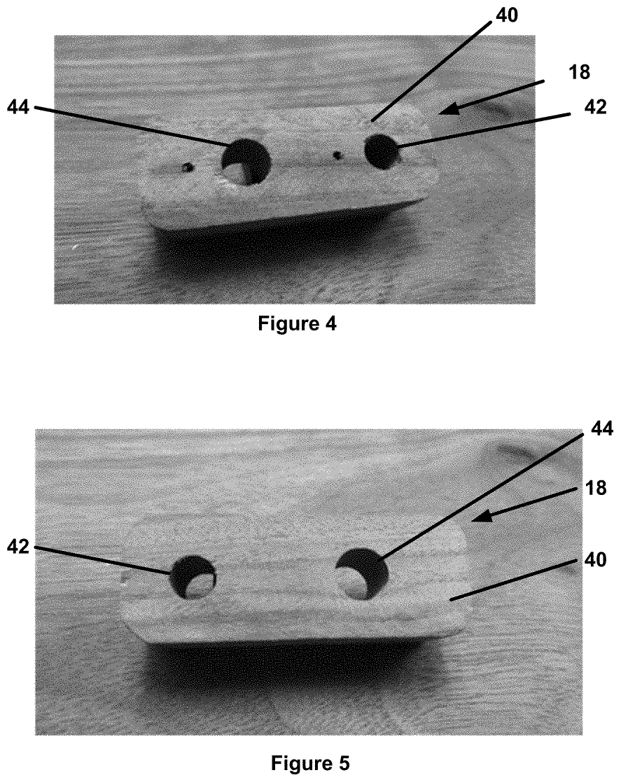

FIGS. 4 and 5 are respective front and back side views of a tensioner block 40 of a tensioner device 18 according to one embodiment of the present invention. As depicted the tensioner block 40 comprises first 42 and second 44 through holes. The first through hole 42 is configured for receipt of the second end 14b of the pivot arm 14, and the second through hole 44 is configured for receipt of the tensioning system 46 (discussed later below).

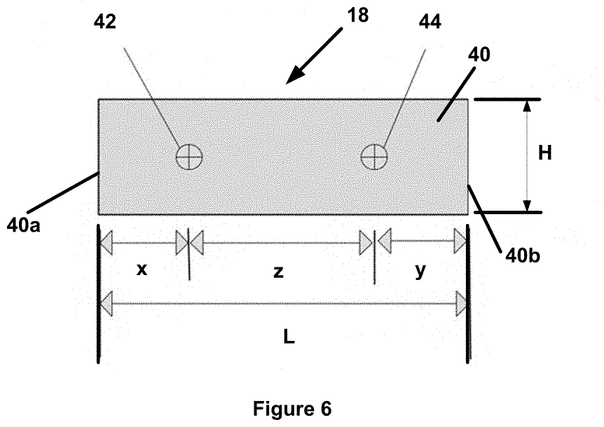

With reference to FIG. 6, one embodiment of the tensioner block 40 is described in terms of its dimensions. In this embodiment, the first through hole 42 has a diameter of one-fourth of an inch (¼″) to frictionally fit the second end 14b of the pivot arm 14. The second through hole 44 has a diameter of five-sixteenths of an inch ( 5/16″) for receipt, possibly frictionally, of the tensioning system 46. The length L of the tensioner block of this embodiment is one and seven-eights inches (1⅞″), and its height H is three-quarter inches (¾″), with the first and second through holes (42, 44) centered vertically on the tensioner block. The center of the first through hole 42 is positioned horizontally three-eighths of an inch (⅜″) from a first side 40a of the tensioner block 40 (illustrated with label x), and the center of the second through hole 44 is positioned horizontally five-eighths inches (⅝″) from a second side 40b of the tensioner block 40 (illustrated with label y), and the distance center-to-center between the first and second through holes 42 and 44 is seven-eighths inches (⅞″).

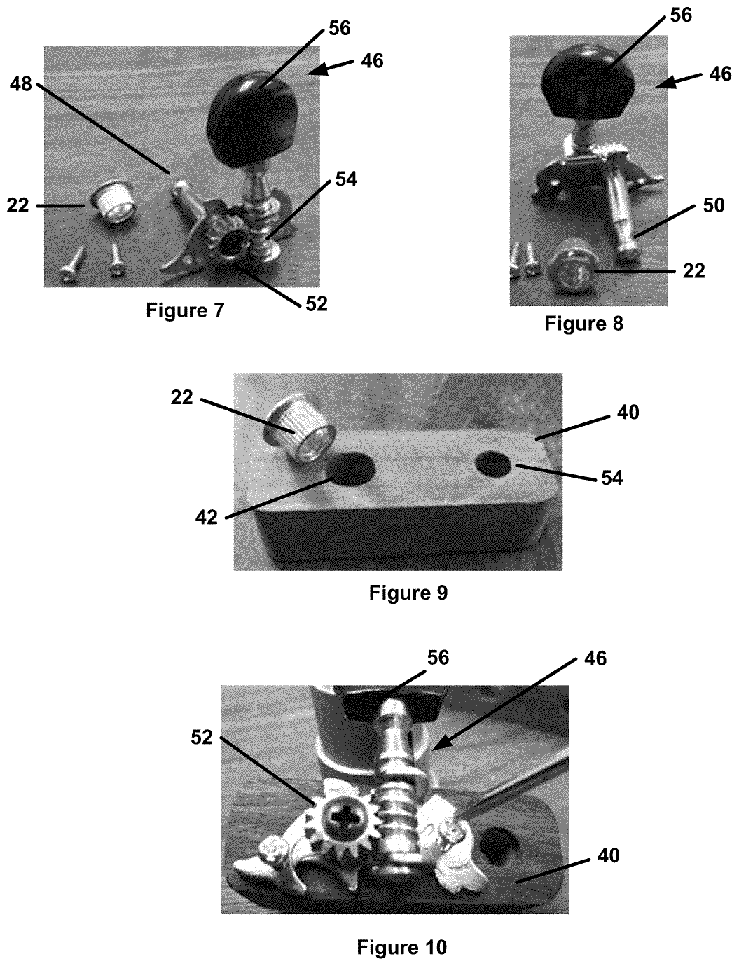

FIGS. 7 and 8 are respectively front and back views of a tensioning system 46 used in a tension device according to one embodiment of the present invention. The tensioning system includes a cylinder 48 configured for receiving the second end of the slicing element 16, such as by insertion of the second end of the slicing element 16 into a through hole 50 in the cylinder 48. A pinion gear 52 may be coupled to the cylinder 48 and a worm drive 54 may be positioned in contact with the pinon gear and an adjustment knob 56, such that rotation of the adjustment knob thereby rotates the cylinder to thereby adjust the tension on the slicing element 16. As shown in FIGS. 9 and 10, a trim ring 22 is inserted into the back side of the first through hole 42 and the cylinder 48 in inserted into the front side of the first through hole 42 for supporting rotation of cylinder in the hole 42. Fasteners are then used to connect the tensioning system 46 to the tensioner block 40.

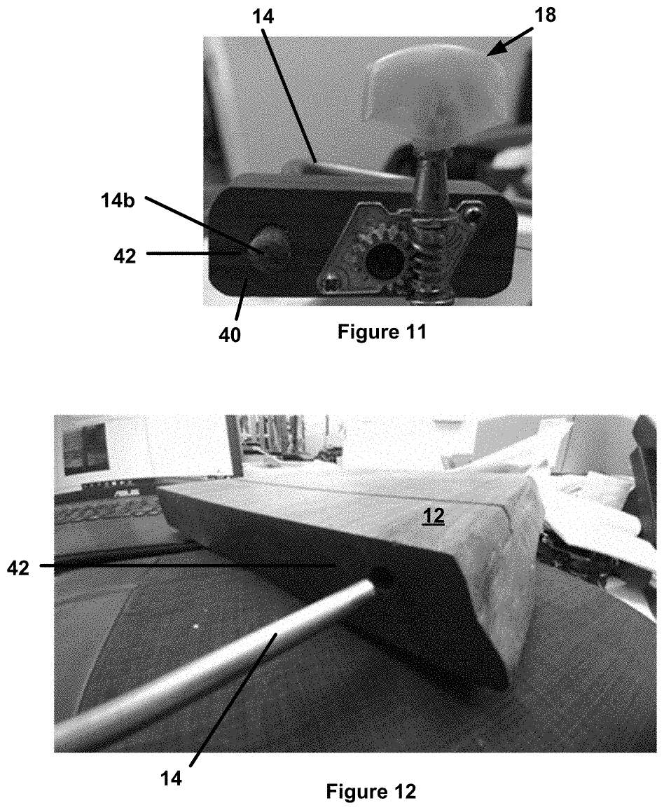

FIG. 11 illustrates the tensioner device 18 of FIGS. 9 and 10 coupled to a second end 14b of a pivot arm 14 by insertion of the second end 14b into the second through hole 44 from the back side of the hole 44 via a pressure fit, according to one embodiment of the present invention. While a pressure fit connection is illustrated, it is understood that a fastener or adhesive could be used to connect the tensioner device to the pivot arm.

FIG. 12 illustrates the first end 14a of the pivot arm 14, according to one embodiment of the present invention, rotatably coupled to a side edge 32 of the cutting surface. The connection is via a semi compression fit in the shown embodiment so that the pivot arm may pivot relative to the cutting surface. In some embodiments an intermediate bearing could be coupled between the pivot arm and the side edge to promote rotation of the pivot arm.

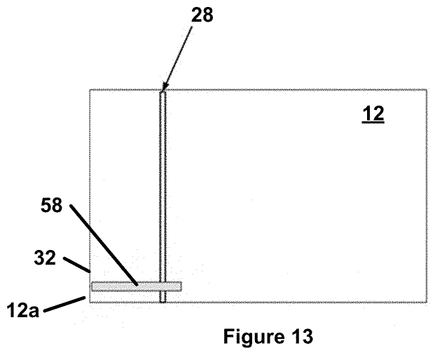

FIG. 13 is a top view of the cutting surface 12 according to one embodiment of the present invention. As illustrated, the groove 28 is formed in the cutting surface 12. In one embodiment, the groove 28 is three-eighths inches (⅜″) deep in the cutting surface 12. A bore hole 58 is located in the side edge 32 of the cutting surface 12. The bore hole 58 is dimensioned to receive the first end 14a of the pivot arm. In one embodiment, the bore hole 58 is centered vertically in the side edge 14, but in other embodiments, the bore hole is located in the upper vertical portion of the side edge 32 above the vertical center line of the side edge, such as three-eighths inches (⅜″) from the top of the side edge 32. The bore is approximately three inches (3″) deep, has a diameter of seventeen-sixty fourths inches ( 17/64″) and offset three-quarter inches (¾″) from the first end 12a of the cutting surface 12.

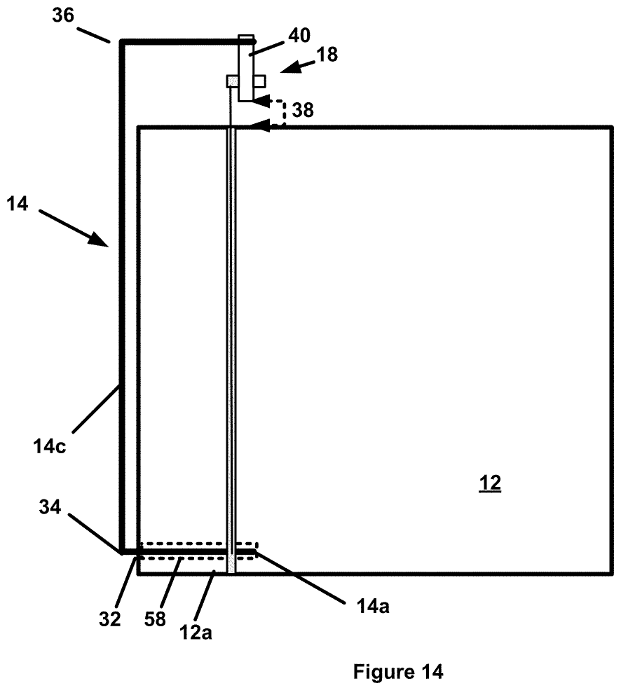

FIG. 14 is a top view of the pivot arm 14 according to one embodiment of the present invention. The pivot arm 14 of this embodiment includes a first bend 34 adjacent to the first end 14a of the pivot arm 14 and a second bend 36 adjacent to the second end 14b of the pivot arm 14. The bends (34, 36) can be any suitable angle but are typically substantially 90 degrees. In one embodiment, each of the first and second bends (34, 36) are respectively located three and one-half inches (3½″) from the respective ends (14a, 14b) of the pivot arm 14.

The length 14c of the pivot arm 14 between the first and second bends (34, 36) is sized based on a length of the side edge 32 of the cutting surface 12 between the first and second ends (12a, 12B) of the cutting surface 12 and the placement of the bore hole 58. As discussed previously, the length 14c of the pivot arm 14 is selected so that the second end 14b of the pivot arm extends past the second end 12b of the cutting surface 12 so that an offset 38 is provided between the tension block 40 and the second end 12b of the cutting surface 12 so as to ensure clearance of the tensioner device 18 when the pivot arm 14 is rotated downward toward the cutting surface 12.

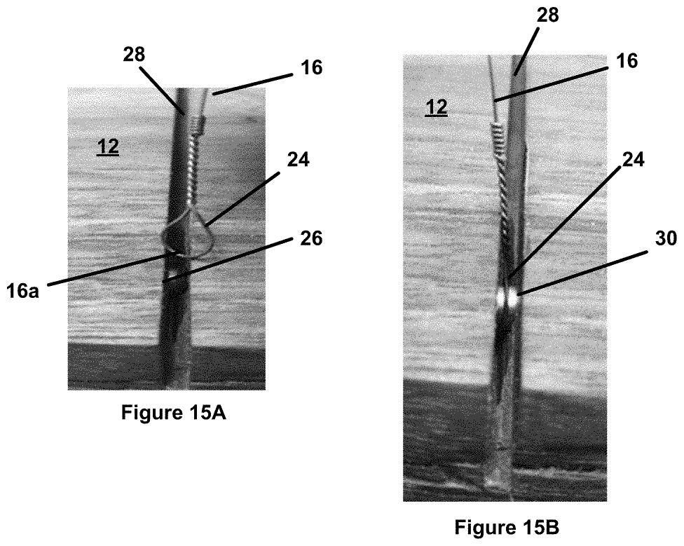

FIGS. 15A and 15B depict assembly of the first end 16a of the slicing element 16 to the cutting surface 12. The first end 16a of the slicing element 16 includes a loop 24 that is configured to receive a pin 30 located in a horizontal hole 26 in the cutting surface 12, such that the slicing element 16 may rotate relative to the cutting surface 12 once assembled with the cutting surface 12. In one embodiment, the loop 24 is formed by tying a haywire twist with a barrel roll.

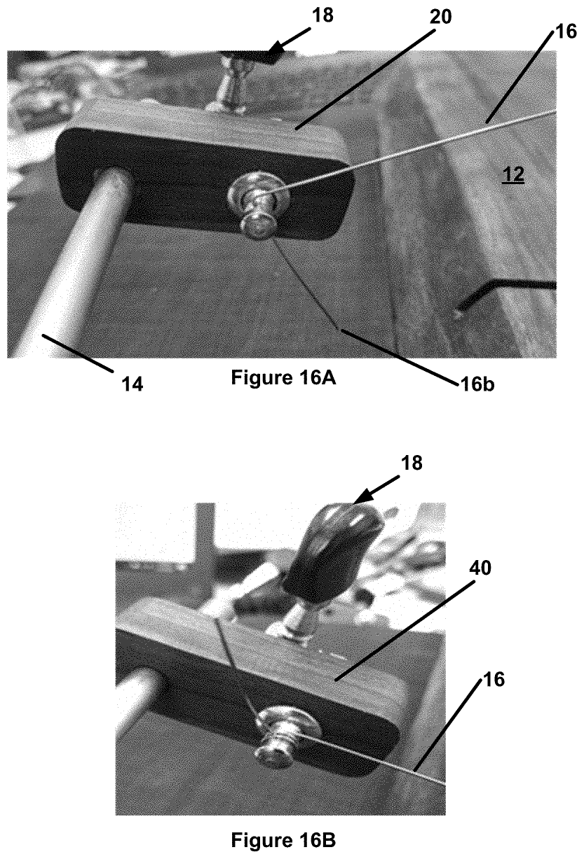

FIGS. 16A and 16B depicts assembly of the second end 16b of the slicing element 16 to the tensioner device 18. Specifically, the second end 16b of the slicing element is threaded through the through hole 50 of the cylinder 48. Once inserted, the cylinder 48 is rotated via the knob 56 pull taunt the slicing element 16 relative to the coupling of the first end 16a of the slicing element 16 to the cutting surface 12.

As will be understood, in the depicted embodiment, the tension on the slicing element 16 may adjusted by the tensioner device 18. Tension can be varied by the user depending on desired performance of the cutting system and based on the type of food being sliced.

The slicing element may comprise any structure capable of cutting/slicing through material. For example, the slicing element may be metallic wire, cotton rope, nylon rope, or rope formed of a polymer or plastic material. In one embodiment, the slicing element is a #10 gauge or smaller gauge stainless steel wire. The slicing element, in other embodiments, might also comprise a structure other than wire, rope, or string. For example, it could be a thin blade structure that is connected to wire on its second end for coupling to the tensioner device.

The cutting surface may be of any suitable material for supporting food while being sliced, such as wood, metal, plastic, glass, stone, or combinations thereof.

The tension device can be any structure suitable for applying a tension to the slicing element, and in some embodiments, an adjustable tension. In one embodiment, the tension device is akin to a guitar string tensioner, such as described herein. But, in general, structures that are capable of coupling to an end of the slicing element and applying a tension thereto are contemplated, such a rotatably cylinder that can be resistant to rotation so as to hold tension on the slicing element. The tensioning device could be a device similar to a come along inch or a motorized winch for wrapping the end of the slicing element about a drum to tighten the tension on the slicing element.

The features, functions, and advantages that have been discussed may be achieved independently in various embodiments of the present invention or may be combined with yet other embodiments, further details of which can be seen with reference to the following description and drawings.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A food slicing system comprising:
a cutting surface extending between first and second ends;
a slicing element having a first end pivotably coupled to the cutting surface adjacent to the first end of the cutting surface;
a pivot arm having a first end pivotably coupled to the cutting surface adjacent to the first end of the cutting surface, wherein both the pivot arm and the slicing element have respective lengths extending toward a second end of the cutting surface; and
a tensioner device configured to couple a second end of the slicing element to a second end of the pivot arm, wherein the tensioner device is configured to allow for adjustment of an amount of tension applied to the slicing element.

2. A food slicing system according to claim 1, wherein said tensioner device comprises a cylinder on which the second end of the slicing element is coiled for adjusting a tension applied to the slicing element.

3. A food slicing system according to claim 2, wherein said tensioner device comprises and adjustment knob coupled to said cylinder to thereby rotate said cylinder to thereby adjust the tension applied to the slicing element.

4. A food slicing system according to claim 1, wherein said tensioner device comprises:
a cylinder configured to couple to the second end of the slicing element;
a pinion gear coupled to said cylinder;
a worm drive in contact with said pinon gear; and
an adjustment knob coupled to said worm drive, such that rotation of said adjustment knob thereby rotates said cylinder to thereby adjust the tension on the slicing element.

5. A food slicing system according to claim 1, wherein the respective second ends of said slicing element and said pivot arm extend past the second end of the cutting surface.

6. A food slicing system according to claim 1, wherein said pivot arm comprises a body extending between the first and second ends of said pivot arm, wherein a portion of the body of said pivot arm is offset from the cutting surface, so that when rotated toward the cutting surface, said pivot arm may rotate past the cutting surface to thereby ensure that the slicing element at least contacts the cutting surface.

7. A food slicing system according to claim 6, wherein said cutting surface comprises a groove in said cutting surface extending at least partially from the first end of the cutting surface to the second end of the cutting surface for receiving the slicing element when the pivot arm is brought toward the cutting surface and past the cutting surface.

8. A food slicing system according to claim 1, wherein said pivot arm comprises a body extending between the first and second ends of said pivot arm, and wherein said body of said pivot arm comprises a first bend at a position on the body adjacent to and off-set from the first end of said body.

9. A food slicing system according to claim 8, wherein the first end of said body of said pivot arm is rotatably coupled to a side of the cutting surface, such that, due to the first bend, the pivot arm is offset from the side of the cutting surface.

10. A food slicing system according to claim 8, wherein the body of said pivot arm comprises a second bend at a position on the body adjacent to and off-set from the second end of said body.

11. A food slicing system according to claim 8, wherein the slicing element is one of a metallic wire, cotton rope, nylon rope, or rope formed of a polymer or plastic material.

12. A food slicing system according to claim 1, wherein the second end of said pivot arm extends past the second end of said cutting surface.

13. A food slicing system according to claim 12, wherein said tensioner device has an associated length extending from a position where the second end of said pivot arm is coupled said tensioner device toward the second end of said cutting surface, wherein the a, wherein the second end of the pivot arm extends past the second end of the cutting surface so as to define an offset distance between the second end of said cutting surface and the tensioner device.

14. A food slicing system according to claim 1, wherein the first end of the slicing element forms a loop that is connected to a pin in said cutting surface.
